(19) United States
(12) Patent Application Publication
(10) Pub. No.: US 2026/0057881 A1
(43) Pub. Date: Feb. 26, 2026

(54) USING ANTI-CONTEXT EXAMPLES FOR UPDATING AUTOMATIC SPEECH RECOGNITION SYSTEMS

(71) Applicant: Google LLC, Mountain View, CA (US)

(72) Inventors: Khe Chai Sim, Dublin, CA (US); Mason Vijay Chua, Mountain View, CA (US); Rajiv Mathews, Sunnyvale, CA (US); Mingqing Chen, Saratoga, CA (US); Dan Zivkovic, Mountain View, CA (US)

(73) Assignee: Google LLC, Mountain View, CA (US)

(21) Appl. No.: 19/104,940

(22) PCT Filed: Sep. 7, 2022
(86) PCT No.: PCT/US2022/076067

§ 371 Date: Feb. 19, 2025

(51) Int. Cl. G10L 15/06; G10L 13/08; G10L 15/22; G10L 15/26

(52) U.S. Cl. CPC G10L 15/063; G10L 13/08; G10L 15/22; G10L 15/26; G10L 2015/223; G10L 2015/225

(57) ABSTRACT

A method (400) for using anti-context examples for personalizing a speech recognition model (132) includes receiving audio data (104) corresponding to an utterance (102) spoken by a user (10), and processing, using the speech recognition model, the audio data to generate a transcription (106) of the utterance. The transcription including a misrecognized phrase (144) that was misrecognized in the transcription by the speech recognition model. The method also includes receiving user-corrected text (141) including a corrected phrase (146) that replaces the misrecognized phrase that was misrecognized in the transcription. Based on the misrecognized phrase, the method includes generating an anti-context example (305) including anti-context text (310) containing the misrecognized phrase paired with text-to-speech (TTS) audio data (315) corresponding to a synthesized speech representation of the anti-context text. The method also includes personalizing the speech recognition model based on the anti-context example.

### TECHNICAL FIELD

This disclosure relates to generating and using anti-context examples for updating automatic speech recognition (ASR) systems.

### BACKGROUND

ASR systems provide a technology that is typically used in mobile devices and/or other devices. In general, ASR systems attempt to provide accurate transcriptions of what a user speaks to a device. However, in some instances, ASR systems generate transcriptions that may not match what the user intended or actually spoke. In these instances, the user may correct a transcription by providing user input(s) that correct the transcription.

### SUMMARY

One aspect of the disclosure provides a method for using anti-context examples for updating ASR systems that, when executed data processing hardware, causes the data processing hardware to perform operations. The operations include receiving audio data corresponding to an utterance spoken by a user, and processing, using a speech recognition model, the audio data to generate a transcription of the utterance. Here, the transcription includes a misrecognized phrase that was misrecognized in the transcription by the speech recognition model. The operations also include receiving user-corrected text including a corrected phrase that replaces the misrecognized phrase that was misrecognized in the transcription. The operations further include, based on the misrecognized phrase, generating an anti-context example. Here, the anti-context example includes anti-context text containing the misrecognized phrase paired with text-to-speech (TTS) audio data corresponding to a synthesized speech representation of the anti-context text. The operations also include personalizing the speech recognition model based on the anti-context example.

Implementations of the disclosure may include one or more of the following optional features. In some implementations, the operations further include displaying the transcription on a graphical user interface of a user device. In some examples, receiving the user-corrected text includes receiving a user input indicating selection of the misrecognized phrase in the transcription displayed on the graphical user interface, and receiving, from the user, input of the user-corrected text. In these examples, receiving the input of the user-corrected text includes receiving a textual input of the user-corrected text provided by the user. Alternatively, receiving the input of the user-corrected text includes receiving streaming audio captured by the user device that corresponds to the user speaking one or more letters of the corrected phrase.

In some implementations, generating the anti-context example includes, based on the user-corrected text, determining, using a language model, the anti-context text containing the user-corrected text. In these implementations, the operations further include providing the anti-context text to a TTS system. Here, the TTS system is configured to convert the anti-context text into the TTS audio data including the synthesized speech representation of the anti-context text. In some examples, the operations also include determining a domain of the utterance spoken by the user. Here, the language model is trained on training textual utterances associated with the domain of the utterance spoken by the user. In these examples, the domain of the utterance includes a long-form speech domain, and the training textual utterances is sampled from at least one of an input method editor (IME) text source or a dictation text source. Alternatively, the domain of the utterance includes a query domain; and the training textual utterances is sampled from a query log.

In some implementations, personalizing the speech recognition model includes training the speech recognition model on the anti-context example by teaching the speech recognition model to learn how to predict the anti-context text from the TTS audio data. In some examples, the operations further include personalizing the speech recognition model by training the speech recognition model on a positive training example including the user-corrected text paired with the audio data to teach the speech recognition model to learn how to predict the user-corrected text from the audio data corresponding to the utterance spoken by the user. In some implementations, personalizing the speech recognition model includes executing an evaluation routine to test performance of the speech recognition model by processing, using the speech recognition model, the TTS audio data to generate a speech recognition result, and determining whether the speech recognition result satisfies acceptance criteria based on the anti-context text, and one of accepting the speech recognition model when the speech recognition result satisfies the acceptance criteria, or rejecting the speech recognition model when the speech recognition result fails to satisfy the acceptance criteria.

Another aspect of the disclosure provides a system for using anti-context examples for updating ASR systems. The system includes data processing hardware and memory hardware in communication with the data processing hardware. The memory hardware stores instructions that, when executed on the data processing hardware, cause the date processing hardware to perform operations including receiving audio data corresponding to an utterance spoken by a user, and processing, using a speech recognition model, the audio data to generate a transcription of the utterance. Here, the transcription includes a misrecognized phrase that was misrecognized in the transcription by the speech recognition model. The operations also include receiving user-corrected text including a corrected phrase that replaces the misrecognized phrase that was misrecognized in the transcription. The operations further include, based on the misrecognized phrase, generating an anti-context example. Here, the anti-context example includes anti-context text containing the misrecognized phrase paired with text-to-speech (TTS) audio data corresponding to a synthesized speech representation of the anti-context text. The operations also include personalizing the speech recognition model based on the anti-context example.

Implementations of the disclosure may include one or more of the following optional features. In some implementations, the operations further include displaying the transcription on a graphical user interface of a user device. In some examples, receiving the user-corrected text includes receiving a user input indicating selection of the misrecognized phrase in the transcription displayed on the graphical user interface, and receiving, from the user, input of the user-corrected text. In these examples, receiving the input of the user-corrected text includes receiving a textual input of the user-corrected text provided by the user. Alternatively, receiving the input of the user-corrected text includes receiving streaming audio captured by the user device that corresponds to the user speaking one or more letters of the corrected phrase.

In some implementations, generating the anti-context example includes, based on the user-corrected text, determining, using a language model, the anti-context text containing the user-corrected text. In these implementations, the operations further include providing the anti-context text to a TTS system. Here, the TTS system is configured to convert the anti-context text into the TTS audio data including the synthesized speech representation of the anti-context text. In some examples, the operations also include determining a domain of the utterance spoken by the user. Here, the language model is trained on training textual utterances associated with the domain of the utterance spoken by the user. In these examples, the domain of the utterance includes a long-form speech domain, and the training textual utterances is sampled from at least one of an input method editor (IME) text source or a dictation text source. Alternatively, the domain of the utterance includes a query domain; and the training textual utterances is sampled from a query log.

In some implementations, personalizing the speech recognition model includes training the speech recognition model on the anti-context example by teaching the speech recognition model to learn how to predict the anti-context text from the TTS audio data. In some examples, the operations further include personalizing the speech recognition model by training the speech recognition model on a positive training example including the user-corrected text paired with the audio data to teach the speech recognition model to learn how to predict the user-corrected text from the audio data corresponding to the utterance spoken by the user. In some implementations, personalizing the speech recognition model includes executing an evaluation routine to test performance of the speech recognition model by processing, using the speech recognition model, the TTS audio data to generate a speech recognition result, and determining whether the speech recognition result satisfies acceptance criteria based on the anti-context text, and one of accepting the speech recognition model when the speech recognition result satisfies the acceptance criteria, or rejecting the speech recognition model when the speech recognition result fails to satisfy the acceptance criteria.

The details of one or more implementations of the disclosure are set forth in the accompanying drawings and the descriptionuserow. Other aspects, features, and advantages will be apparent from the description and drawings, and from the claims.

### DESCRIPTION OF DRAWINGS

FIG. 1 is a schematic view of an example system for using anti-context examples for updating an automatic speech recognition (ASR) system.

FIG. 2A-2C are schematic views of a user providing input(s) to correct a transcription.

FIG. 3 is a schematic view depicting an anti-context example generator for generating anti-context examples.

FIG. 4 is a flowchart of an exemplary arrangement of operations for a method of generating and using anti-context examples for updating a speech recognition system.

FIG. 5 is a schematic view of an example computing device that may be used to implement the systems and methods described herein.

Like reference symbols in the various drawings indicate like elements.

### DETAILED DESCRIPTION

Automatic speech recognition (ASR) systems are becoming increasingly popular in client devices as the ASR systems continue to provide more accurate transcriptions of what users speak. Still, in some instances, ASR systems may generate inaccurate transcriptions when they misrecognize what the user actually spoke or intended. This may be the case when words are acoustically similar, or when the user speaks a unique, uncommon, or rare word unknown to the ASR system. For example, a user may speak a proper name, such as “Khe Chai” that the ASR system may not be able to recognize due to the proper name not being present in training data used to train the ASR system. As a result, the ASR system may incorrectly transcribe what the user spoke as another word or phrase (e.g., “kitchen”) that is acoustically similar to “Khe Chai”. In some examples, the user corrects the original transcription using a client device (e.g., inputting corrected text via a keyboard, microphone, etc. of the client device). For example, the client device may display a transcription on a graphical user interface and the user may select a misrecognized phrase (e.g., “kitchen”) in the original transcription (e.g., “My name is kitchen”) displayed on the graphical user interface, and thereafter provide user-corrected text including a corrected phrase (e.g., “Khe Chai”) that is to replace the misrecognized phrase in a corrected transcription (e.g., “My name is Khe Chai”) displayed on the graphical user interface.

One particular difficulty of ASR systems is how to leverage these user corrections to generate more accurate transcriptions for subsequent utterances. For instance, if the user repeatedly speaks the proper name “Khe Chai” in subsequent utterances resulting in the ASR system repeatedly misrecognizing the proper name as “kitchen,” the user may lose trust in the ASR system. Thus, in some examples, a training example containing the corrected transcription, or at least the corrected phrase, and captured audio data representing what the user spoke may be used to update a speech recognition model to better personalize the speech recognition model for recognizing proper names spoken by the user, such that the speech recognition model may learn to recognize, or better recognize, the corrected phrase (e.g., a proper name). Such training examples are referred to herein as “positive examples” because they positively train, or reinforce, the speech recognition model's ability to correctly recognize the corrected phrase.

However, personalizing a speech recognition model based on user corrections to mistranscribed utterances can have the unintended consequence of the speech recognition model “overlearning” where the speech recognition model loses the ability to correctly transcribe a spoken utterance that actually includes a common phrase (e.g., “kitchen) that was previously misrecognized, and then corrected and replaced with a corrected phrase (e.g., “Khe Chai”). For example, the personalization of the speech recognition model to accurately recognize utterances spoken by the user that contain the proper name “Khe Chai” instead of the acoustically similar phrase “kitchen”, may result in the speech recognition model misrecognizing the phrase/word “kitchen” as “Khe Chai” even though the user actually spoke the phrase “kitchen”. That is, just because the user intended to convey “Khe Chai” in some utterances, does not mean the user will never intend to convey acoustically similar terms such as “kitchen” in another utterance at a later time.

Implementations herein are directed toward preventing overlearning of speech recognition models from user-corrected text by levering anti-context examples containing a misrecognized phrase (e.g., “kitchen”) and text-to-speech (TTS) audio data corresponding to synthesized speech representations of the misrecognized phrase. As will become apparent, the speech recognition model may also be updated on the TTS audio data paired with anti-context text containing the misrecognized phrase to help reduce the likelihood that the speech recognition model will mistranscribe utterances spoken by the user that actually contain the misrecognized phrase. In some instances, the text used for such an anti-context example (e.g., a longer phrase including the misrecognized phrase, such as “I am in the kitchen”) need not relate to the context, domain, meaning, intention, etc. of the original utterance (e.g., “My name is Khe Chai”) and, thus, such text is referred to herein as “anti-context text.” Moreover, training examples based on such “anti-context text,” which are based on misrecognized phrases, are accordingly referred to herein as “anti-context examples” to distinguish them from positive training examples based on user-corrected text.

Implementations herein are more specifically directed to systems and methods for generating and using anti-context examples to prevent a speech recognition model from over-biasing recognition toward terms/phrases that the user corrected in transcriptions of utterances previously spoken by the user. In particular, a speech recognition model executing on a computing device processes audio data corresponding to an utterance spoken by a user to generate a transcription that includes a phrase that was misrecognized by the speech recognition model. The computing device may display the transcription including the misrecognized phrase on a graphical user interface and subsequently receive user-corrected text including a corrected phrase that replaces the misrecognized phrase to provide a corrected transcription for display in the graphical user interface that now contains the corrected phrase. While the user-corrected text and corresponding audio data may be used to personalize the speech recognition model for accurately transcribing subsequent utterances that contain the corrected phrase, the computing device also mitigates the likelihood of the speech recognition model from over biasing recognition toward the corrected phrase in subsequent utterances spoken by the where the user actually speaks the phrase that was previously misrecognized as the misrecognized phrase by further personalizing the speech recognition model on one or more anti-context examples. Here, when the user provides user-corrected text to replace a misrecognized phrase that was misrecognized in a transcription of an utterance spoken by the user, the computing device generates a corresponding anti-context example based on the misrecognized phrase where the anti-context example includes anti-context text containing the misrecognized phrase paired with TTS audio data corresponding to a synthesized speech representation of the anti-context text. As used herein, the personalizing of the speech recognition model based on the anti-context example may include training the speech recognition model on the anti-context example by teaching the speech recognition model to learn how to predict the anti-context text from the TTS audio. Additionally or alternatively, the personalizing of the speech recognition model based on the anti-context example may include using the anti-context example for evaluating performance of the speech recognition model to determine whether the speech recognition model is able to accurately transcribe the TTS audio data corresponding to the synthesized speech representation of the anti-context text.

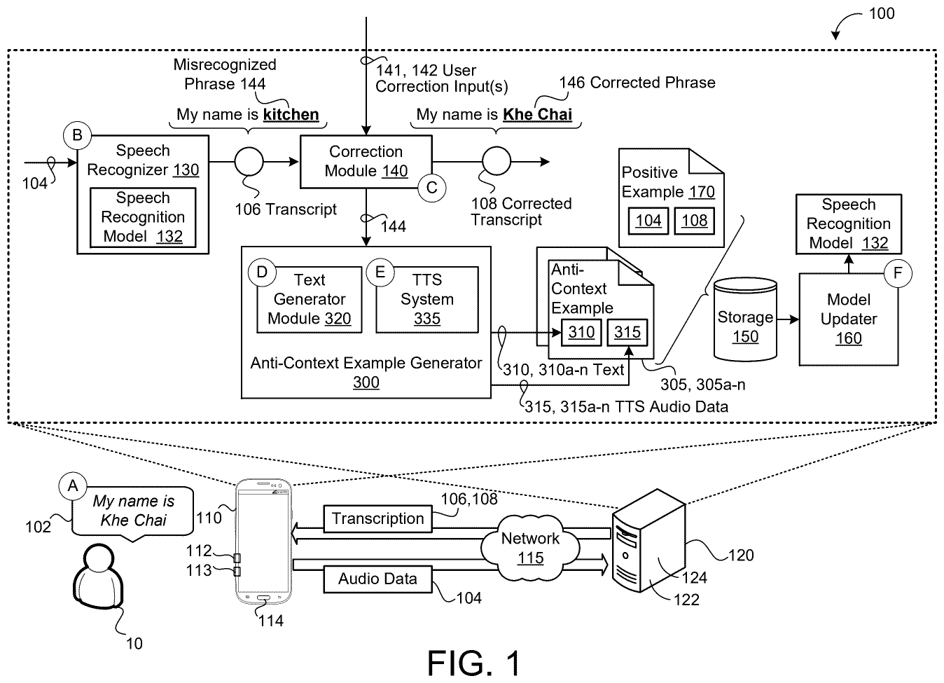

FIG. 1 illustrates an example of a system 100 for performing ASR on recorded audio data 104 corresponding to an utterance 102 (e.g., a query, command, etc.) spoken by a user 10. The system 100 includes a client device 110. In some examples, the client device 110 is in communication with a computing system 120 via a network 115. The computing system 120 may be a distributed system (e.g., a cloud computing environment) having scalable elastic resources. The resources include computing resources 122 (e.g., data processing hardware) and/or storage resources 124 (e.g., memory hardware). The network 115 can be wired, wireless, or a combination thereof, and may include private networks and/or public networks, such as the Internet.

In some examples, the computing system 120 receives or otherwise obtains the audio data 104 from the client device 110, and the computing system 120 processes the audio data 104, using ASR, to generate an original transcription 106 for the utterance 102 based on the audio data 104.

FIG. 1 shows operations (A) to (F) which illustrate a flow of data. As described herein, the computing system 120 performs operations (B) to (F). However, it is understood that the client device 110 may also perform one or more of the operations (B) to (F) in addition to, or in lieu of, the computing system 120 performing the operations. In some examples, the client device 110 performs a first portion of the operations (e.g., operations (A), (B), and (C)) and the computing system 120 performs a second portion of the operations (e.g., operations (D) to (F)), or vice-versa. Moreover, in some examples, another computing system different from the client device 110 and the computing system 120 (not shown for clarity of illustration) performs operation (F).

The client device 110 includes data processing hardware 112 and memory hardware 113. The client device 110 may include one or more audio capture devices (e.g., microphone(s)) 114 for capturing and converting utterances 102 from the user 10 into the audio data 104 (e.g., digital data or electrical signals). In some examples, the microphone 114 is separate from the client device 110 and in communication with the client device 110 to provide the utterance 102 to the client device 110. The client device 110 can be any computing device capable of communicating with the computing system 120 through the network 115. The client device 110 includes, but is not limited to, desktop computing devices and mobile computing devices, such as laptops, tablets, smart phones, smart keyboards, digital assistants, smart speakers/displays, smart appliances, vehicle infotainment systems, Internet-of-things (IOT) devices, and wearable computing devices (e.g., headsets and/or watches).

In the example of FIG. 1, during operation (A), the user 10 speaks an utterance 102, and the microphone 114 of the client device 110 captures the spoken utterance 102. In this example, the utterance 102 includes the user 10 speaking “My name is Khe Chai.” In some examples, the client device 110 transmits the audio data 104, corresponding to the utterance 102 captured by the microphone 114, to the computing system 120 via the network 115. In other examples, the client device 110 processes the audio data 104 locally in addition to, or in lieu of, transmitting the audio data 104 to the computing system 120.

During operation (B), the computing system 120 (or the client device 110) processes the audio data 104 to generate an original transcription 106 for the utterance 102. For example, the computing system 120 may execute a speech recognizer 130 (e.g., using a speech recognition model 132) for producing the original transcription 106 (e.g., “My name is kitchen”). Notably, the original transcription 106 contains a misrecognized phrase (e.g., “kitchen”) that was misrecognized by the speech recognizer 130 instead of the phrase (“Khe Chai”) actually spoken by the user 10.

In some implementations, the speech recognizer 130 includes an end-to-end (E2E) speech recognition model configured to receive the audio data 104 and generate a word lattice. In particular, the E2E speech recognition model processes the audio data 104 to generate corresponding likelihood scores for each of multiple candidate hypotheses in the word lattice. In some examples, the speech recognizer 130 includes a separate acoustic model, language model, and/or pronunciation model. The speech recognizer 130 may share an acoustic model and a language model with an additional hypothesis scorer (e.g., acoustic model and language model) or have an independent acoustic model and language model. In some examples, the speech recognizer 130 includes the acoustic model and/or the language model to generate the word lattice or otherwise generate the multiple candidate hypotheses for the utterance 102 based on the audio data 104. Here, the likelihood scores of the multiple candidate hypotheses may include a combination of an acoustic modeling score from the acoustic model and/or a prior likelihood score from the language model. Put another way, the likelihood scores includes at least one of the acoustic modeling score output by the acoustic model and/or the prior likelihood score output by the language model. The speech recognizer 130 may identify the highest-ranking candidate hypotheses from multiple candidate hypotheses in the word lattice as the original transcript 106. As used herein, the terms “transcription” and “transcript” may be used interchangeably.

During operation (C), the computing system 120 (or the client device 110) executes a correction module 140 that generates a corrected transcription 108 in response to one or more user correction inputs 142 indicating selection or identification of a misrecognized phrase 144 (e.g., “kitchen) of the original transcription 106, and user-corrected text 141 that includes a corrected phrase 146 (e.g., “Khe Chai”) to replace the misrecognized phrase 144. The misrecognized phrase 144 may include one or more respective words, word pieces, characters/graphemes, numbers, punctuations, etc. Similarly, the corrected phrase 146 may include one or more respective words, word pieces, characters/graphemes, numbers, punctuations, etc. In some examples, the correction module 140 generates the corrected transcription 108 by replacing more than one misrecognized phrases 144 that were misrecognized in the original transcription 106 by the speech recognizer 130 with respective corrected phrases 146.

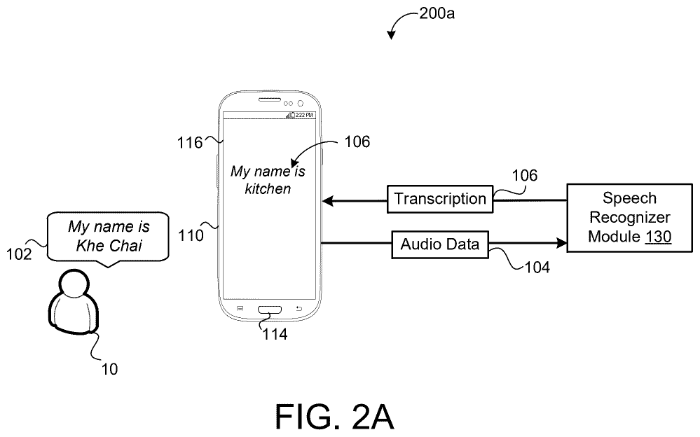

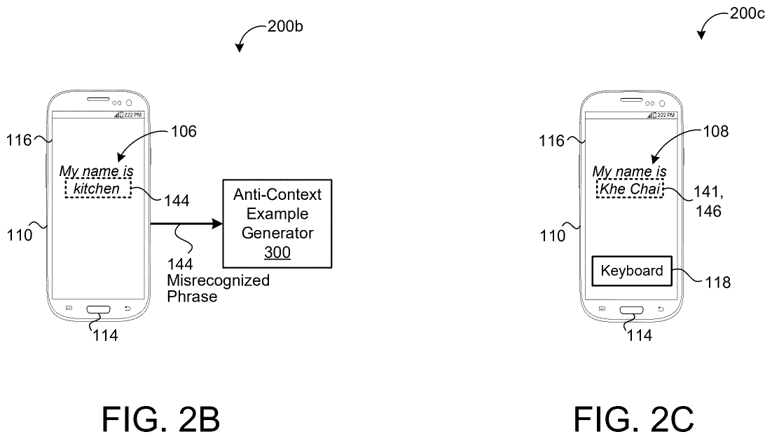

FIGS. 2A-2C illustrate examples of a user-correction of an original transcription 106 containing a misrecognized phrase 144 for producing a corrected transcription 108 that includes a corrected phrase 146 instead of the misrecognized phrase 144 (see FIG. 1). In some implementations, the speech recognizer 130 generates the transcript 106 that includes the misrecognized phrase 144 of the utterance 102 spoken by the user 10.

Schematic view 200a of FIG. 2A illustrates the microphone 114 of the client device 110 capturing the user 10 speaking the utterance 102 “My name is Khe Chai.” The client device 110 converts the utterance 102 to audio data 104, and transmits or otherwise provides the audio data 104 to the speech recognizer 130. The speech recognizer 130 processes the audio data 104 to generate the original transcription 106 corresponding to the audio data 104 (e.g., “My name is kitchen”). In the example shown, the original transcription 106 represents or includes a misrecognition of the utterance 102 spoken by the user 10. As shown, the client device 110 displays the original transcription 106 to the user 10 via a graphical user interface (GUI) 116. In other examples, the client device executes the speech recognizer 130 locally on the data processing hardware 112 (FIG. 1) to process the audio data 104 and generate the transcription 106.

Referring now to the schematic view 200b of FIG. 2B, the user 10 may identify that the original transcription 106 displayed on the GUI 116 does not match the utterance 102 since the transcription 106 includes a misrecognized phrase 144 that was not spoken by the user 10 in the utterance 102. As such, the user 10 may provide one or more inputs 142 to the GUI 116 of the client device 110 that indicate a selection or identification of the misrecognized phrase 144 in the transcription 106 that that was misrecognized by the speech recognizer 130. In some examples, the input(s) 142 include the user 10 providing a touch input to the GUI 116 that selects the misrecognized phrase 144 (e.g., “kitchen”) from the transcription 106. The misrecognized phrase 144 may include the entire transcription 106 or a portion thereof. In the example shown, the misrecognized phrase 144 only includes a portion of the transcription 106. As shown, the client device 110 transmits, or otherwise provides, the misrecognized phrase 144 to an anti-context example generator 300.

Referring now to the schematic view 200c of FIG. 2C, the user 10 may replace the misrecognized phrase 144 in the original transcription 106 with user-corrected text including a corrected phrase 146 (e.g., “Khe Chai”) to form the corrected transcription 108. In some examples, the user 10 uses a physical or virtual keyboard 118 of the client device 110 to provide the user-corrected text 141 including the corrected phrase 146. The keyboard 118 may optionally display responsive to the client device 110 receiving the input indication from the user 10 (FIG. 2B). In these examples, the user 10 may type in the user-corrected text containing the corrected phrase 146 using the physical or virtual keyboard 118 of the client device 110. In other examples, the user 10 inputs the user-corrected text of the corrected phrase 146 by speaking to the client device 110. That is, the user 10 may speak each letter of the user-corrected text of the corrected phrase 146 (e.g., “K-H-E space C-H-A-I”). The client device 110 may receive the utterances of the user 10 as streaming audio captured by the client device 110, and process, using speech recognition for example, the streaming audio to recognize the one or more spoken letters of the user-corrected text. After receiving the user-corrected text 141 including the corrected phrase 146, the client device 110 may replace the misrecognized phrase 144 with the corrected phrase 146 to generate the corrected transcription 108 that represents an accurate transcription of the utterance 102.

Referring back to FIG. 1, during operations (D) and (E), the computing system 120 executes the anti-context example generator 300 for generating one or more anti-context examples 305, 305a-n based on the misrecognized phrase 144 in the original transcript 106. Each anti-context example 305 contains respective anti-context text 310, 310a-n based on the misrecognized phrase 144 paired together with respective TTS audio data 315, 315a-n corresponding to synthesized speech representations of the respective anti-context text 310, 310a-n.

In the example shown, the client device 110 and/or the computing system 120 may store the generated anti-context examples 305 on one or more local or remote storage resources 150 (e.g., residing on the memory hardware 113 of the client device 110 and/or the memory hardware 124 of the computing system 120) for subsequent retrieval and use by a model updater 160 for personalizing, updating, adapting, training, etc. a speech recognition model (e.g., the speech recognition model 132) during operation (F). In some examples, anti-context example the model updater 160 uses the anti-context examples 305 to update the speech recognition model 132 in real time during operation (F).

In some examples, the model updater 160 executes an evaluation routine to test performance of the personalized speech recognition model 132 by processing, using the speech recognition model 132, the TTS audio 315 of the anti-context examples 305 to generate one or more speech recognition results. The model updater 160 may then determine whether the speech recognition result(s) satisfy an acceptance criteria based on the anti-context text. When the speech recognition result(s) satisfy an acceptance criteria, the module updater 160 accepts the personalized speech recognition model 132. The module updater 160 may reject the personalized speech recognizer model 132 when the speech recognition results do not satisfy the acceptance criteria.

In some examples, the client device 110 or the computing system 120 generates a positive training example 170 containing the recorded audio data 104 and the corrected transcript 108, or a portion thereof (e.g., the corrected phrase 146). Similar to the anti-context examples 305, the client device 110 and/or the computing system 120 may store the positive training example 170 on the one or more storage resources 150 for subsequent retrieval and use by the model updater 160 for personalizing, updating, adapting, training, etc. a speech recognition model (e.g., the speech recognition model 132). In some examples, the model updater 160 uses the positive training example 170 to update the speech recognition model 132 in real time.

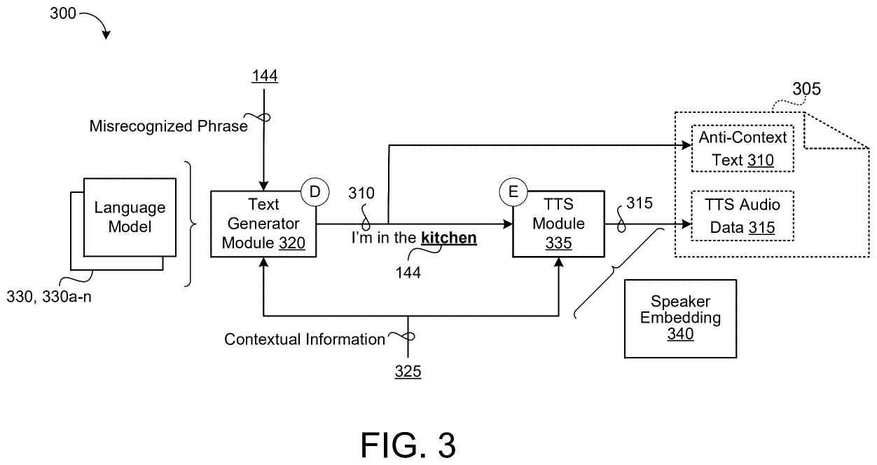

As described in greater detail below with reference to FIG. 3, the anti-context example generator 300 includes a text generator module 320 for generating the anti-context text 310 at operation (D) and a TTS system 335 for generating the corresponding TTS audio 315 at operation (E). The client device 110 may execute the text generator module 320 locally for generating the anti-context text 310, and then transmit the anti-context text 310 to the TTS system 335 executing on the computing system 120 for generating the TTS audio 315. However, the text generator module 320 and the TTS system 335 may both execute locally on the client device 110 or remotely on the computing system 120 without departing from the scope of the present disclosure.

Referring now to FIG. 3, during operation (D), the text generator module 320 generates the anti-context text 310 (e.g., “I am in the kitchen”) based on the misrecognized phrase 144 (e.g., “kitchen”) extracted from the original transcription 106. The text generator module 320 may leverage a language model 330 that receives the misrecognized phrase 144 and generates the anti-context text 310 containing the misrecognized phrase 144. Notably, the anti-context text 310 output from the language model 330 includes a textual utterance that contains the misrecognized phrase 144. While the example shown depicts the text generator module 320 generating only one instance of anti-context text 310 for simplicity, the text generator module 320 may generate multiple instances of anti-context text 310, 310a-n that each include a respective sentence that contains misrecognized phrase 144 (e.g., “I am in the kitchen” and “The stove is in the kitchen”).

In some implementations, the text generator module 320 generates anti-context text 310 based on another misrecognized phrase (e.g., “keychain”) extracted from another speech recognition hypothesis in a lattice of speech recognition hypotheses predicted by the speech recognition model 132 for the input audio data 104 characterizing the utterance (e.g., “My name is Khe Chai”). Each hypothesis in the lattice corresponds to a possible transcription of the utterance and may be assigned a confidence score by the speech recognizer 130. For instance, the original transcription 106 having the misrecognized phrase 144 (“kitchen”) depicted in FIG. 1 may include the speech recognition hypothesis having a highest score/confidence in the lattice of speech recognition hypotheses, while one or more other hypotheses in the lattice with lower score/confidence may include other possible misrecognized phrases. Accordingly, the text generator module 320 may generate anti-context text 310 based on misrecognized phrases extracted from any of the speech recognition hypotheses in the lattice.

In some examples, the text generator module 320 generates the anti-context text 310 based on contextual information 325 (e.g., application identifier, device identifier, user identifier, etc.) indicating a domain associated with the utterance 102 (e.g., a query, a command, etc.). In these examples, the text generator module 320 may select, from a plurality of language models 330, 330a-n each associated with a different respective domain, a language model 330 associated with the domain indicated by the contextual information 325 for use in generating the anti-context text 310. As a result, the anti-context text 310 includes a textual utterance of a sentence/query/command containing the misrecognized phrase 144 that is associated with a domain the speech recognition model 132 is used in to better personalize the speech recognition model 132 and prevent over-learning thereof. For example, the text generator module 320 may determine a domain based on an application identifier identifying an application (e.g., a digital assistant) that the utterance 102 is directed towards. For instance, the utterance 102 may be “Hey Google, call Khe Chai on mobile” indicating that the user 10 invoked a digital assistant application, or the utterance 102 could be “send the following message to Mom [contents of message].” The contextual information 325 may also indicate a length of the original utterance 102 for use by the text generator module 320 to distinguish between generating anti-context text 310 associated with a long-form utterance (i.e., a long-form speech domain) or a short query utterance (e.g., a query domain).

The language models 330 may be trained on respective training textual utterances associated different domains, contexts, etc. For example, the language models 330 may be trained using training textual utterances sampled from at least one of input method editor (IME) text sources, dictation text sources (e.g., text or email messages, free form dictation, reminders, etc.), or query logs (e.g., queries input to a digital assistant or voice search engine such as “What is the temperature,” or queries input to a navigation app, etc.). In some implementations, the language models 330 are anonymously trained on training textual utterances sampled from sources that do not include any data extracted from, or otherwise associated with, the user.

In other implementations, at least one language model 330 is trained on training textual utterances sampled from query logs (voice commands) or other typed history (search engine queries) input by the user 10. In these implementations, the user 10 explicitly consents to sharing personal data for use by the language model 330 for generating anti-context text 310 for better personalizing the speech recognition model 132 for the user. The user 10 may revoke consent to sharing personal data at any time. In some examples, when the client device 110 determines that both the text generator module 320 and the TTS System 335 execute entirely on-device (as well as the model updater 160 and speech recognition model 132), the client device 110 permits the text generator module 320 to leverage a language model 330 trained on training textual utterances personal to the user. In doing so, neither the anti-context text 310 nor the resulting TTS audio 315 is shared over the network and kept entirely on-device so that all data personal to the user 10 kept private and secure.

During operation (E), the anti-context example generator 300 executes the TTS system 335 to generate the TTS audio data 315 corresponding to the synthesized speech representation of the anti-context text 310 generated by the text generator module 320 during operation (D). That is, the TTS system 335 may convert the anti-context text 310 into the TTS audio data 315. In some examples, the anti-context text 310 includes a sequence of phonemes input to the TTS system 335 for conversion into the TTS audio data 315. In some examples, the TTS module 335 is conditioned on a speaker embedding 340 associated with the user 10 to permit the TTS system 335 to generate TTS audio data 315 having speaker characteristics associated with the user 10. In these examples, the TTS system 335 may use the contextual information 325 (e.g., application identifier, device identifier, user identifier, etc.) to uniquely identify the user 10, and obtain the speaker embedding 340 for that user 10.

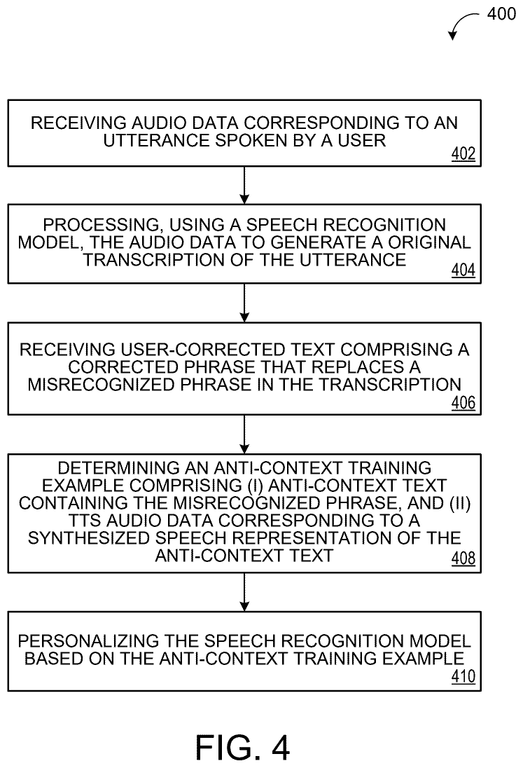

FIG. 4 is a flowchart of an exemplary arrangement of operations for a method 400 of generating and using anti-context examples to personalize a speech recognition model. Data processing hardware 510 (e.g., the data processing hardware 112 of the client device 110 and/or the data processing hardware 122 of the computing system 120 of FIG. 1) may execute the operations for the method 400 by executing instructions stored on memory hardware 520 (e.g., the memory hardware 113, 124). At operation 402, the method 400 includes receiving audio data 104 corresponding to an utterance 102 spoken by a user 10. At operation 404, the method 400 includes processing the audio data 104 using a speech recognition model 132 to generate an original transcription 106 of the utterance 102.

At operation 406, the method 400 includes receiving user-corrected text including a corrected phrase 146 that replaces the misrecognized phrase 144 that was misrecognized in the transcription 106. Here, the method 400 may receive the one or more user inputs 142 (FIGS. 1 and 2A-2D) that indicate selection or identification of the misrecognized phrase 144 of the original transcription 106, and provide the user-correct text including the corrected phrase 146 that is to replace the misrecognized phrase 144 in the corrected transcription 108 of the utterance 102.

At operation 408, the method 400 includes generating one or more anti-context examples 305 based on the misrecognized phrase 144. Here, each anti-context example 305 contains anti-context text 310 generated based on the misrecognized phrase 144 paired together with TTS audio data 315 corresponding to a synthesized speech representation of the anti-context text 310.

At operation 410, the method 400 includes personalizing the speech recognition model 132 based on the anti-context example(s) 305. In some examples, personalizing the speech recognition model 132 includes the model updater 160 (FIG. 1) training the speech recognition model 132 on the one or more anti-context examples 305 by teaching the speech recognition model 132 to learn how to predict the anti-context text 310 from the TTS audio data 315. For instance, the anti-context text 310 may serve as a ground truth for an ASR result predicted by the speech recognition model 132 based on processing the TTS audio data 315, whereby the model updater 160 may update parameters of the speech recognition model 132 using supervised learning techniques such stochastic gradient descent via back propagation of a training loss based on the anti-context text 310 and the predicted ASR result. Accordingly, the model updater 160 may update parameters of the speech recognition model 132 based on the anti-context example(s) 305 to mitigate over-learning by the speech recognition model 132 which may occur when the model 132 is updated based on user-corrected text 142 replacing a phrase 144 previously misrecognized in an original transcription 106 with corrected phrases 146. Additionally, personalizing the speech recognition model 132 may include training the speech recognition model 132 on a positive training example including the user-corrected text paired with the audio data 104 to teach the speech recognition model 132 to learn how to predict the user-corrected text from the audio data corresponding to the utterance 102 spoken by the user 10.

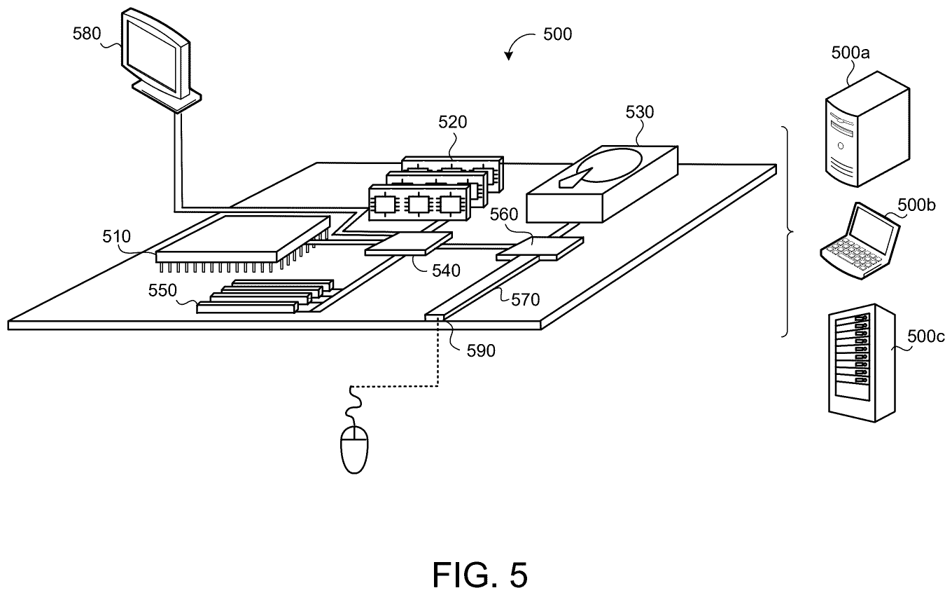

In some additional examples, personalizing the speech recognition model 132 includes executing an evaluation routine to test performance of the speech recognition model 132 by processing, using the speech recognition model 132, the TTS audio data 315 to generate a speech recognition result and determining whether the speech recognition result satisfies acceptance criteria based on the anti-context text 310. Here, the anti-context text 310 may include a ground-truth for the speech recognition result output by the speech recognition model 132 based on processing the TTS audio data 315 such that a word error rate may be determined and compared to acceptance criteria corresponding to a word error rate threshold. In these examples, the evaluation routine accepts the speech recognition model 132 when the speech recognition result satisfies the acceptance criteria. Here, the speech recognition model 132 may generate an accurate speech recognition result from the TTS audio data 315 that matches the anti-context text 310 to indicate that the acceptance criteria is satisfied, thereby indicating that the speech recognition model 132 has not lost performance due to over-learning when recognizing an utterance of that includes the misrecognized phrase 144. On the other hand, the evaluation routine rejects the speech recognition model 132 when the speech recognition result fails to satisfy the acceptance criteria. For instance, the speech recognition result may fail to satisfy the acceptance criteria when speech recognition model 132 fails to recognize the misrecognized phrase 144 in the TTS audio data 315, thereby indicating that performance of the speech recognition model 132 is degraded as a result of over-learning. In scenarios when the evaluation routine rejects the speech recognition model, the model updater 160 may train/update parameters of the speech recognition model 132 based on the anti-context example 305 as discussed above. For instance, rejection of the speech recognition model 132 by the evaluation routine may trigger the anti-context example generator 300 to generate additional anti-context examples 305 based on the misrecognized phrase 144 for use by the model updater 160 in updating/training the speech recognition model 132 to learn (or re-learn) how to predict anti-context text containing the misrecognized phrase 144 from corresponding TTS audio data 144. FIG. 5 is schematic view of an example computing device 500 that may be used to implement the systems and methods described in this document. For example, the computing device 500 may be used to implement the client device 110 and/or the computing system 120. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510 that may be used to implement the data processing hardware 112 and/or 122, memory 520 that may be used to implement the memory hardware 113 and/or 124, a storage device 530 that may be used to implement the memory hardware 113 and/or 124, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus, and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, “or” refers to an inclusive or and not to an exclusive or. For example, “A, B, or C” refers to any combination or subset of A, B, C such as: (1) A alone; (2) B alone; (3) C alone; (4) A with B; (5) A with C; (6) B with C; and (7) A with B and with C. Similarly, the phrase “at least one of A or B” is intended to refer to any combination or subset of A and B such as: (1) at least one A; (2) at least one B; and (3) at least one A and at least one B. As used herein, the phrase “at least one of A and B” is intended to refer to any combination or subset of A and B such as: (1) at least one A; (2) at least one B; and (3) at least one A and at least one B.

A number of implementations have been described. Nevertheless, it will be understood that various modifications may be made without departing from the spirit and scope of the disclosure. Accordingly, other implementations are within the scope of the following claims.

1. A computer-implemented method executing on data processing hardware causes the data processing hardware to perform operations comprising:
receiving audio data corresponding to an utterance spoken by a user;
processing, using a speech recognition model, the audio data to generate a transcription of the utterance, the transcription comprising a misrecognized phrase that was misrecognized in the transcription by the speech recognition model;
receiving user-corrected text comprising a corrected phrase that replaces the misrecognized phrase that was misrecognized in the transcription;
based on the misrecognized phrase, generating an anti-context example, the anti-context example comprising anti-context text containing the misrecognized phrase paired with text-to-speech audio data corresponding to a synthesized speech representation of the anti-context text; and
personalizing the speech recognition model based on the anti-context example.

2. The computer-implemented method of claim 1, wherein the operations further comprise:
displaying the transcription on a graphical user interface of a user device,
wherein receiving the user-corrected text comprises:
receiving a user input indicating selection of the misrecognized phrase in the transcription displayed on the graphical user interface; and
receiving, from the user, input of the user-corrected text.

3. The computer-implemented method of claim 2, wherein receiving the input of the user-corrected text comprises receiving a textual input of the user-corrected text provided by the user.

4. The computer-implemented method of claim 2, wherein receiving the input of the user-corrected text comprises receiving streaming audio captured by the user device that corresponds to the user speaking one or more letters of the corrected phrase.

5. The computer-implemented method of claim 1, wherein generating the anti-context example comprises:
based on the user-corrected text, determining, using a language model, the anti-context text containing the user-corrected text; and
providing the anti-context text to a TTS system, the TTS system configured to convert the anti-context text into the TTS audio data comprising the synthesized speech representation of the anti-context text.

6. The computer-implemented method of claim 5, wherein the operations further comprise:
determining a domain of the utterance spoken by the user,
wherein the language model is trained on training textual utterances associated with the domain of the utterance spoken by the user.

7. The computer-implemented method of claim 6, wherein:
the domain of the utterance comprises a long-form speech domain; and
the training textual utterances are sampled from at least one of an input method editor text source or a dictation text source.

8. The computer-implemented method of claim 6, wherein:
the domain of the utterance comprises a query domain; and
the training textual utterances are sampled from a query log.

9. The computer-implemented method of claim 1, wherein personalizing the speech recognition model comprises training the speech recognition model on the anti-context example by teaching the speech recognition model to learn how to predict the anti-context text from the TTS audio data.

10. The computer-implemented method of claim 1, wherein the operations further comprise personalizing the speech recognition model by training the speech recognition model on a positive training example comprising the user-corrected text paired with the audio data to teach the speech recognition model to learn how to predict the user-corrected text from the audio data corresponding to the utterance spoken by the user.

11. The computer-implemented method of claim 1, wherein personalizing the speech recognition model comprises executing an evaluation routine to test performance of the speech recognition model by:
processing, using the speech recognition model, the TTS audio data to generate a speech recognition result;
determining whether the speech recognition result satisfies acceptance criteria based on the anti-context text; and
one of:
accepting the speech recognition model when the speech recognition result satisfies the acceptance criteria; or
rejecting the speech recognition model when the speech recognition result fails to satisfy the acceptance criteria.

12. A system comprising:
data processing hardware; and
memory hardware in communication with the data processing hardware and storing instructions that, when executed on the data processing hardware, cause the data processing hardware to perform operations comprising:
receiving audio data corresponding to an utterance spoken by a user;
processing, using a speech recognition model, the audio data to generate a transcription of the utterance, the transcription comprising a misrecognized phrase that was misrecognized in the transcription by the speech recognition model;
receiving user-corrected text comprising a corrected phrase that replaces the misrecognized phrase that was misrecognized in the transcription;
based on the misrecognized phrase, generating an anti-context example, the anti-context example comprising anti-context text containing the misrecognized phrase paired with text-to-speech audio data corresponding to a synthesized speech representation of the anti-context text; and
personalizing the speech recognition model based on the anti-context example.

13. The system of claim 12, wherein the operations further comprise:
displaying the transcription on a graphical user interface of a user device,
wherein receiving the user-corrected text comprises:
receiving a user input indicating selection of the misrecognized phrase in the transcription displayed on the graphical user interface; and
receiving, from the user, input of the user-corrected text.

14. The system of claim 13, wherein receiving the input of the user-corrected text comprises receiving a textual input of the user-corrected text provided by the user.

15. The system of claim 13, wherein receiving the input of the user-corrected text comprises receiving streaming audio captured by the user device that corresponds to the user speaking one or more letters of the corrected phrase.

16. The system of claim 12, wherein generating the anti-context example comprises:
based on the user-corrected text, determining, using a language model, the anti-context text containing the user-corrected text; and
providing the anti-context text to a TTS system, the TTS system configured to convert the anti-context text into the TTS audio data comprising the synthesized speech representation of the anti-context text.

17. The system of claim 16, wherein the operations further comprise:
determining a domain of the utterance spoken by the user,
wherein the language model is trained on training textual utterances associated with the domain of the utterance spoken by the user.

18. The system of claim 17, wherein:
the domain of the utterance comprises a long-form speech domain; and
the training textual utterances are sampled from at least one of an input method editor text source or a dictation text source.

19. The system of claim 17, wherein:
the domain of the utterance comprises a query domain; and
the training textual utterances are sampled from a query log.

20. The system of claim 12, wherein personalizing the speech recognition model comprises training the speech recognition model on the anti-context example by teaching the speech recognition model to learn how to predict the anti-context text from the TTS audio data.

21. The system of claim 12, wherein the operations further comprise personalizing the speech recognition model by training the speech recognition model on a positive training example comprising the user-corrected text paired with the audio data to teach the speech recognition model to learn how to predict the user-corrected text from the audio data corresponding to the utterance spoken by the user.

22. The system of claim 12, wherein personalizing the speech recognition model comprises executing an evaluation routine to test performance of the speech recognition model by:
processing, using the speech recognition model, the TTS audio data to generate a speech recognition result;
determining whether the speech recognition result satisfies acceptance criteria based on the anti-context text; and
one of:
accepting the speech recognition model when the speech recognition result satisfies the acceptance criteria; or
rejecting the speech recognition model when the speech recognition result fails to satisfy the acceptance criteria.
